(19) United States
(12) Patent Application Publication
(10) Pub. No.: US 2003/0165664 A1
(43) Pub. Date: Sep. 4, 2003

(54) Method of making a composite panel and article made thereby

(75) Inventors: Phillip Patrick Carroll III, Bloomfield Hills, MI (US); Ryan Johnson Brooks, Allen Park, MI (US)

Correspondence Address: BROOKS & KUSHMAN, 1000 TOWN CENTER 22ND FL, SOUTHFIELD, MI, 48075

(73) Assignee: Oakwood Custom Coating, Inc., Taylor, MI

(21) Appl. No.: 10/087,050

(22) Filed: Mar. 1, 2002

(51) Int. Cl. B32B 3/10; B32B 1/00; B29C 43/02

(52) U.S. Cl. 428/138; 428/139; 428/151; 264/154; 264/161; 264/293; 264/320; 156/293; 156/245

(57) ABSTRACT

A trim panel (1) and a method of making a trim panel (1) comprising providing a formable sheet (12) having at least one layer, locating the sheet (12) adjacent to a forming surface (80), conforming the sheet (12) to the forming surface (80) so that the sheet (12) has a characterizing topography (15) and removing the sheet (12) from the forming surface (80). A substrate (40) is provided having a rear surface (45) and an opening (55) therethrough. Lastly, the sheet (12) is attached to the rear surface (45) of the substrate (40) so that the characterizing topography (15) extends through the opening (55). Alternatively, the sheet (12) may comprise at least one tab (17) and the substrate (40) may comprise at least one tab opening (57) wherein the tab (17) is inserted into the tab opening (57) to snap-fit the pieces together.

### BACKGROUND OF THE INVENTION

1. Field of the Invention

This invention relates to a method of making a composite panel and the panel made thereby.

2. Background Art

The prior art discloses numerous composite panels with a laminated or otherwise decorated insert. Typically, the composite panel is comprised of a rigid substrate comprising a back side and a front side. The front side of the substrate may comprise portions sometimes referred to as “Class A” surfaces which have a surface finish suitable for a vehicle interior. Frequently, a contrasting look, such as wood grain or metallic trim, is desired on the insert.

Two methods are frequently used to create a composite panel with a contrasting appearance.

In the first method, the substrate having a plurality of holes is injection molded. A separate insert panel having a front side, a rear side, and bosses extending from the rear side is also injection molded. Alternatively, the bosses may be attached to the rear side using, for example, an adhesive. An applique having a wood grain or other finish is thermoformed so that it fits over the insert panel. In a separate operation, the applique is attached to the insert panel using heat, welding, or other bonding means. The applique and insert panel joined to it are then attached to the substrate by inserting the bosses of the insert panel through the holes in the substrate. The bosses extending through the holes in the substrate are then either heat staked or upset to secure the insert panel to the substrate.

One drawback with this technique is that the process of attaching the applique to the insert panel creates undesirable joint lines that are visible on the finished composite panel. Additionally, the parting lines on the insert panel are frequently visible on the assembled composite panel.

A second method, disclosed by Avery Dennison, uses a laminate having a film layer and a backing sheet. The laminate is thermoformed and trimmed into a shell of the desired part shape. The preformed shell is then inserted into a special injection mold cavity having the shape of the final composite panel. The substrate is then injection molded using the same material as the backing sheet, causing a melt bond to form that results in the laminate becoming permanently integrated into the composite panel. This method improves upon the prior art by reducing the appearance of visible joint and parting lines on the composite panel. However, the cost of an insert injection mold is much higher than a regular injection mold and the scrap rate is high because of fit and finish issues.

It would be desirable to provide an economical method of making a composite panel that lacks joint and parting lines.

The prior art includes commonly owned U.S. Pat. Nos. 4,974,698; 5,652,413; and 5,565,659, the disclosures of which are incorporated herein by reference.

### SUMMARY OF THE INVENTION

It is an object of the present invention to provide a more cost-effective, easier to manufacture, and lighter composite panel with no visible joint or parting lines.

The present invention includes a method of making a composite panel. The method comprises providing a formable sheet with at least one layer and locating the sheet adjacent to a forming surface. A formed sheet is made by conforming the formable sheet to the forming surface so that a characterizing topography projects from the formable sheet. The formed sheet is then removed from the forming surface. A substrate is provided having a front surface, a rear surface, and an opening therethrough. The formed sheet is then attached to the rear surface of the substrate so that the characterizing topography extends through the opening.

The substrate further comprises one or more bosses extending from the back surface. The method includes the step of forming openings which serve to locate the formed sheet relative to the substrate. The step of attaching the formed sheet to the substrate comprises placing the formed sheet on the substrate so that at least one of the bosses extends through the openings. The step of attaching the formed sheet to the substrate may also involve heat staking or upsetting the bosses extending through the holes in the formed sheet.

Optionally, the substrate comprises at least one tab opening and the formed sheet has at least one tab. A snap-fit created by forcing the tab through the tab opening secures the formed sheet to the substrate.

Optionally, the formed sheet may be attached with a hook on one edge of the formed sheet and one or more tabs or snaps on other edge or edges.

Optionally, the formed sheet may be adhered to the substrate.

These and other advantages of the present invention will become of apparent to one of ordinary skill in the art in light of the following description and attached drawings.

### BRIEF DESCRIPTION OF THE DRAWINGS

FIG. 1 is a perspective view of an insert panel of the present invention attached to a vehicle door;

FIG. 2 is a perspective view of the front of an embodiment of the insert panel of the present invention;

FIG. 3 is a perspective view of the rear of the substrate;

FIG. 4 is a sectional view of the insert panel placed on the substrate;

FIG. 5 is a sectional view of the insert panel secured to the substrate;

FIG. 6 is a perspective view of the sheet being located in a thermoforming machine;

FIG. 7 is a perspective view of the sheet being located in a vacuum forming machine;

FIG. 8 is a perspective view of the formed sheet located in a trimming machine;

FIG. 9 is a perspective view of a method of attaching the insert panel to the substrate;

FIG. 10 is a flowchart illustrating a method of making a trim panel according to the present invention;

FIG. 11 is a top plan view of tabs on an oval insert panel;

FIG. 12 is another top plan view of tabs on a generally rectangular insert panel;

FIG. 13 is a top plan view of tabs on an alternate embodiment of a insert panel;

FIG. 14 is a cross-sectional view of a first type of tab extending through a substrate;

FIG. 15 is a cross-sectional view of a second type of tab extending through a substrate;

FIG. 16 is a cross-sectional view of a third type of tab extending through a substrate; and

FIG. 17 is a flow chart illustrating an alternate method of making an insert panel according to the present invention.

### DETAILED DESCRIPTION OF THE PREFERRED EMBODIMENT(S)

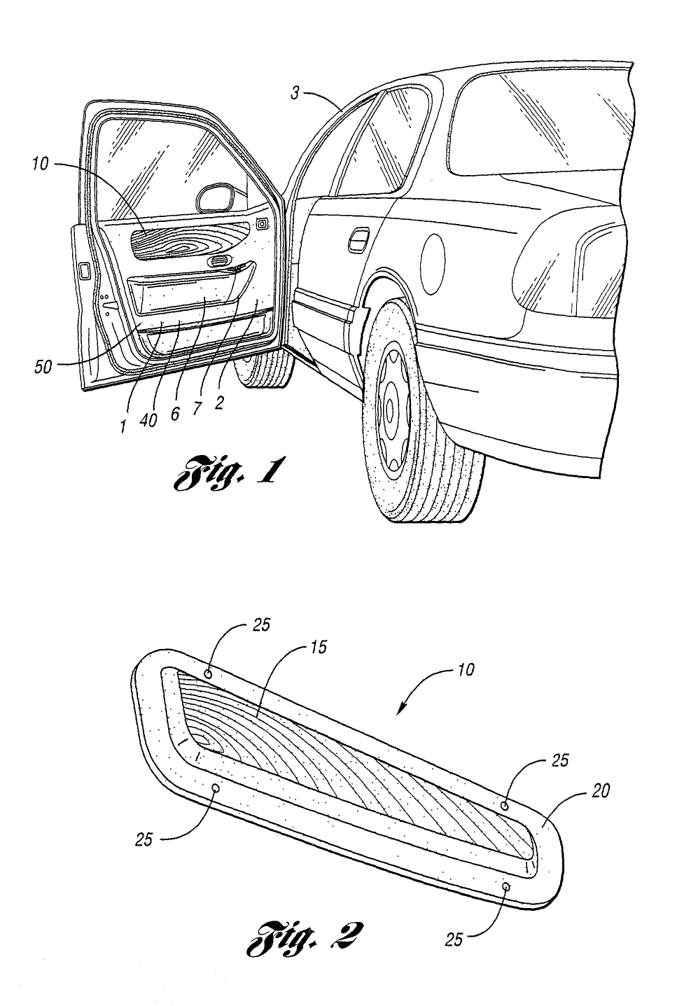

Referring first to FIG. 1, a finished composite panel 1 having a substrate 40 and insert panel 10 according to the present invention is shown in an automotive vehicle 3. Although shown as a door panel for an automotive vehicle, the finished composite panel can also be, but is not limited to, an instrument panel, a speaker grill, a console, an air bag cover, or a seat. Further, although the invention is described for use in an automobile, it can be used in other vehicles such as airplanes, boats, trains, and in non-vehicle related applications.

The substrate 40 has a Class A surface finish 2 as shown, or it may be painted or coated. Carpeting, vinyl, or other coverings (not shown) may also be attached to the substrate. Other features, such as an arm rest 6 or control module 7, may also be attached to the finished composite panel 1.

The invention provides for a composite panel 1 and a method of making a composite panel having an insert panel 10 that has a contrasting appearance from the rest of the composite panel. The insert panel 10 may have, for example, a wood grain finish, which is popular in the higher end automotive vehicles, or a metallic finish, which is popular in sports cars.

Referring now to FIG. 2, an insert panel 10 is depicted having a base 20 which may be flat or contoured and a formed or characterizing topography 15. In FIG. 2, the curved lines 15 suggest, for example, a wood grain finish. They are not meant to represent contour lines. A plurality of openings 25 extend through the base 20. The openings may be round holes, as shown, or, alternatively, slits, keyholes or a variety of other shapes. A stiffening structure (not shown) can be added if desired to increase the rigidity of the insert panel 10.

Preferably, the insert panel 10 is comprised of a laminate material having multiple layers with a total thickness large enough to provide acceptable rigidity to the panel. As described below, the insert panels may be manufactured out of a formable sheet provided in roll form. Commercial sheets are available in a variety of thicknesses including 1.7 mm. A top layer may be a simulated wood grain as suggested in FIG. 2 or some other decorative finish to enhance the appearance of the interior of the vehicle. Other possible finishes include geometric patterns, burl, pearlescent luster, and solid colors.

The wood grain or decorative layer may be protected from the environment by a top layer of protective material. One example of a decorative layer is a laminate material is available from Avery Dennison of Troy, Mich. and sold under the trademark Thermark®. The material comprises a printed film laminated to a compatible plastic backing sheet. The backing sheet can be made out of various resins such as ABS, TPO, and polycarbonate.

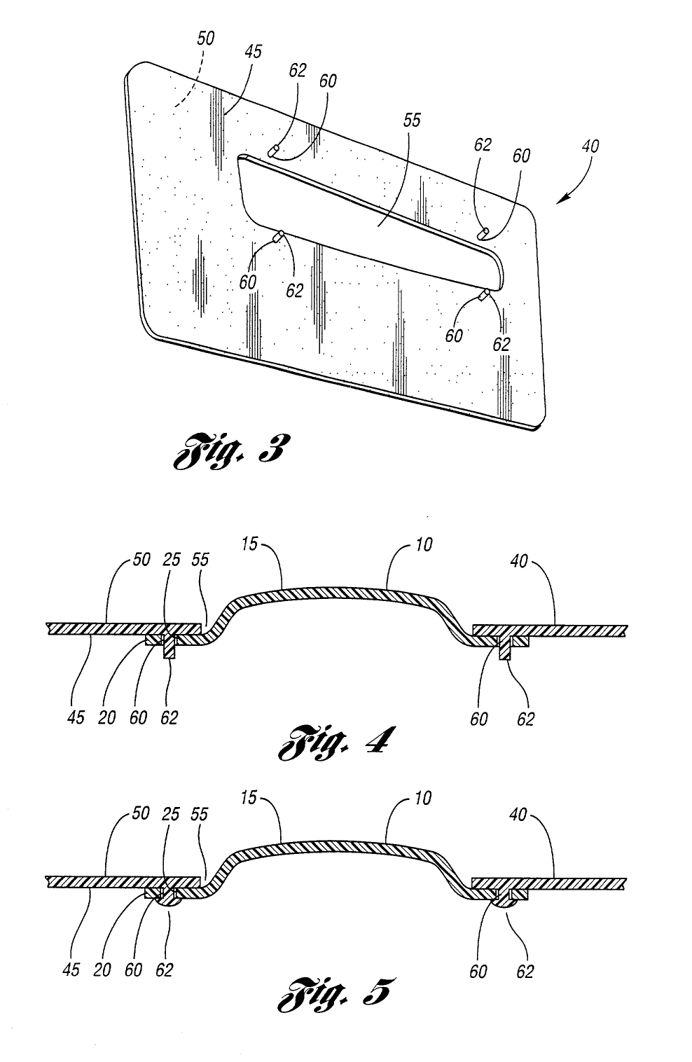

Referring now to FIG. 3, a substrate 40 having a front surface 50 facing the interior of the vehicle and a rear surface 45 is shown. The substrate is preferably molded out of at least a semi-rigid plastic such as ABS, polycarbonate, or TPO. An opening 55, is sized to receive the characterized shape 15. The insert panel 10 creates a contrasting appearance and extends through the substrate 40 when attached. A plurality of bosses 60 having free ends 62 extend from the rear surface 45 of the substrate 40 and are sized and positioned so that the bosses fit into the openings 25 of the sheet 10. Preferably, the bosses 60 are integrally molded in the substrate, but the bosses can also be attached to the substrate in a secondary operation using, for example, an adhesive to minimize the risk of sink marks on the Class A surface. The front surface 50 is frequently embodied in a Class A surface.

Referring now to FIGS. 4 and 5, an insert panel 10 is shown on and attached to the substrate 40, respectively. The insert panel 10 is installed onto the substrate 40 so that the characterizing form 15 extends through the opening 55 of the substrate. The bosses 60 extend through the holes 25 so that the ends 62 protrude through the insert panel 10.

The insert panel 10 can be secured to the substrate 40 using a variety of techniques such as, for example, upsetting the ends 62 so that they form a mechanical lock and secure the insert panel in place. Alternatively, ultrasonic welding, vibration welding, or heat welding may be used. Alternatively, adhesive may be applied to either or both the insert panel 10 and the substrate 40 before the panel is placed on the substrate. If adhesive is used, then holes 25 on the insert panel 10 and bosses 60 on the substrate 40 are not necessary, although the bosses and openings may help align the characterizing topography 15 to the opening 55. Preferably, the bosses 60 are heat staked to form a mechanical lock that secures the insert panel 10 to the substrate 40.

A composite panel 1 made according to this invention does not have any undesirable joint or parting lines around the contrasting panel that are generally present using the prior art methods.

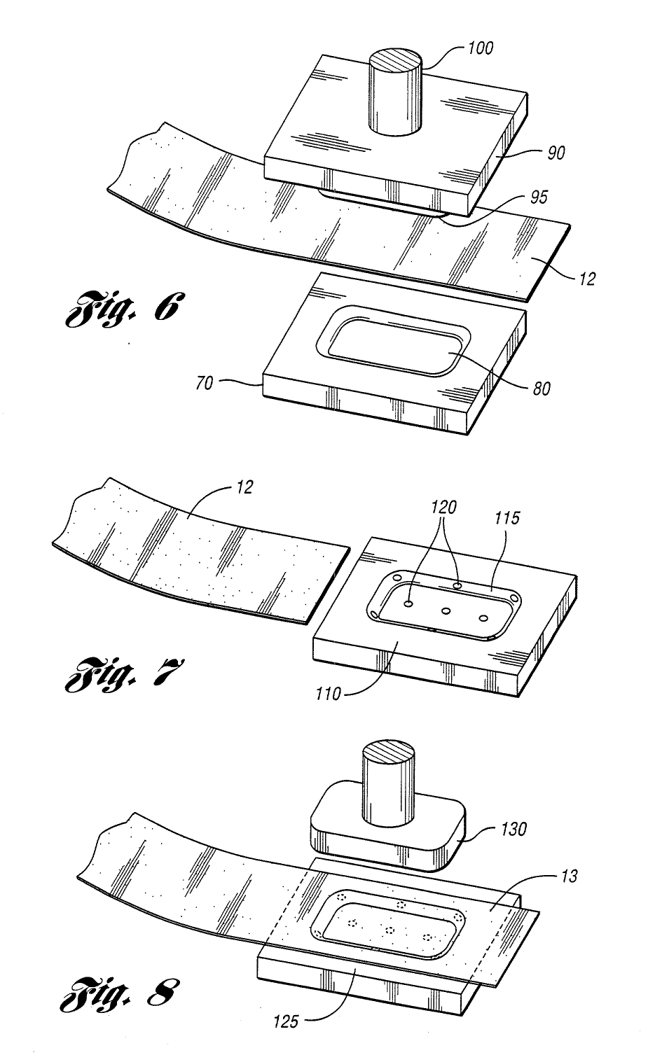

A method of making the composite panel 1 is illustrated and described in FIGS. 6-10. A sheet of laminate 12 from which the insert panel 10 is made is initially provided, often in a roll form although a plate form may be used. Material is unrolled and heated using, for example, infrared radiation to make the material more pliable up to a forming temperature appropriate for the material. The heated sheet of laminate 12 is then preferably shaped using forming surfaces 80 and 95 as shown in FIG. 6. The thermoformed part comprises a base plate 70 with a forming surface cavity 80 in the final desired shape. A plate 90 having a forming surface core 95 conforms the sheet of laminate 12 into the cavity 80 using known means, such as a hydraulic cylinder 100 that defines the topography of a formed sheet 13. Once the formed sheet of laminate 13 has sufficiently cooled so that it retains its shape, the formed sheet of laminate 13 is removed from the thermoformer and is taken to the next station.

As illustrated, the sheet is formed by a male surface 95 pushing the sheet into a female cavity 80. Alternatively a female cavity or a plug may form the sheet over a male forming plate.

Alternatively, the sheet of laminate 12 can be shaped using a vacuum former as shown in FIG. 7. The heated and softened sheet of laminate 12 is positioned over a vacuum forming die 110 having a forming surface 115 of the desired shape. A vacuum pump (not shown) creates a vacuum by drawing air through the vacuum vents 120 in the forming die 110. Vents 120 may be of a variety of formations including holes, rings and slits. Vacuum may also be drawn through passages in porous materials. In this method no macro vents 120 appear. The vacuum conforms the heated sheet of laminate 12 to the forming surface cavity 115 making a formed sheet 13. Once the formed sheet of laminate 13 sufficiently cools so that it can retain its shape, the formed sheet of laminate 13 is removed and moved to the next station.

In one alternative step, the formed sheet of laminate 13 is then trimmed to its final shape by placing it in a holding die 125, as shown in FIG. 8. A cutting die 130 with sharp edges then cuts the insert panel 10 from the formed sheet of laminate 13. Openings may be created in the insert panel 10 using the cutting die 130 or in a subsequent operation using, for example, a water jet cutter (not shown) or another cutting die.

Alternatively, the whole insert panel 10 can be trimmed from the formed sheet of laminate 13 using a water jet or other cutter (not shown).

The last step in the preferred process of making the composite panel 1 of the present invention is to place and secure the insert panel 10 to the substrate 40. As described above, the substrate 40 having a front surface 50 facing the interior of the vehicle and a rear surface 45 is provided. The opening 55 is sized to receive the characterized shape 15 of the insert panel. The characterized shape creates a contrasting appearance by protruding or appearing through the substrate 40. A plurality of bosses 60 having free ends 62 extend from the rear surface 45 of the substrate 40 and are sized and positioned so that the bosses fit into the openings 25 of the sheet 10.

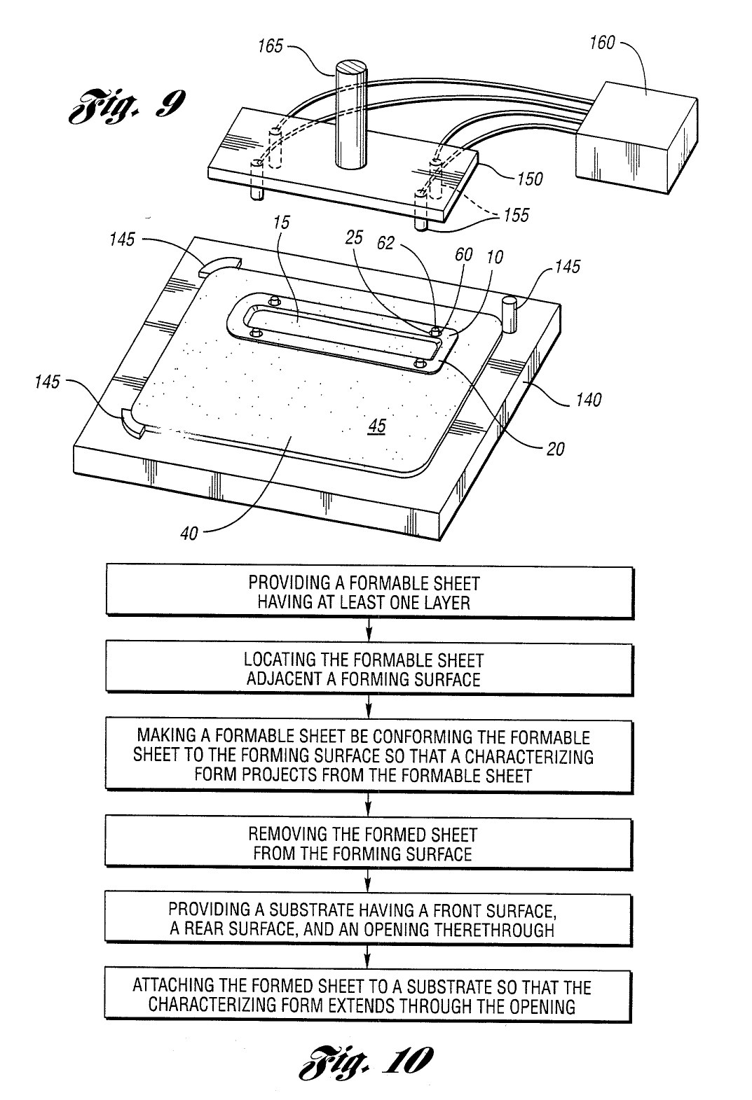

Referring now to FIG. 9, the substrate 40 is placed on a fixture so that the rear surface 45 is facing upwardly. The fixture 140 comprises one or more guide posts 145 to secure and properly align the substrate. The insert panel 10 is then placed on the substrate 40 so that the characterizing form 15 extends through the opening of the substrate (not visible in FIG. 9) and the bosses 60 of the substrate extend through the openings 25 of the insert panel.

Preferably, the insert panel 10 is secured to the substrate 40 using a plate 150 containing a plurality of heating elements 155 connected to a heat control module 160. The plate 150 is movable from a contact position to a non-contact position using a piston 165. In the contact position, the heating elements stake the ends 62 of the bosses 60 as shown in FIG. 5.

The insert panel 10 can also be secured to the substrate 40 by upsetting the ends 62 of the bosses 60 using a similarly designed fixture and plate. Alternatively, adhesive could be used to secure the insert panel 10 in whole or in part to the substrate 40. If adhesive is used, the adhesive should be applied to either or both the insert panel 10 and the substrate 40 before the insert panel is placed on the substrate. FIG. 10 shows the general steps of a thermoformed manufacture and assembly.

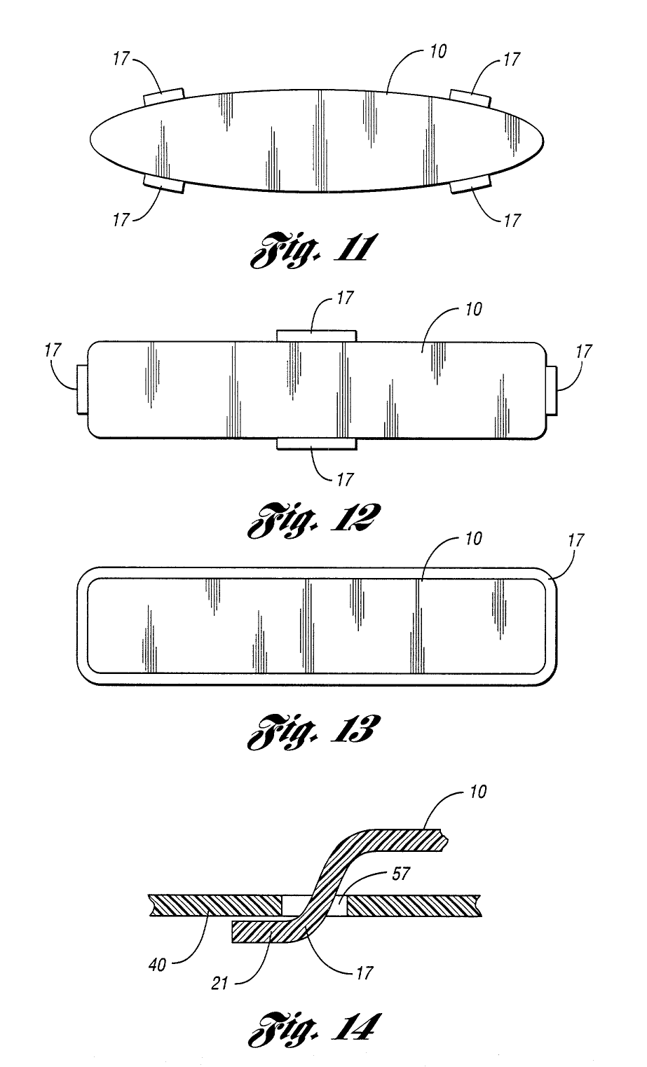

Alternatively, to the heating of bases or stakes (FIG. 9), the insert panel 10 may be secured to the substrate 40 using tabs 17 extending from the insert panel and tab openings 57 in the substrate sized to receive the tabs 17 and hold them in a snap-fit configuration. FIGS. 11-13 show various tabs 17 in plan view. In FIG. 13, the tab 17 encompasses the complete circumference of the insert panel 10.

FIGS. 14-16 show various tabs 17 in tab openings 57. Using the snap-fit method of attaching the insert panel 10 to the substrate 40, there is no need for a large opening 55 through which the characterizing form 15 is inserted from the back side of the substrate. Instead, tab openings 57 are positioned on the substrate 40 to receive the tabs 17 when the insert panel 10 is inserted from the front of the substrate.

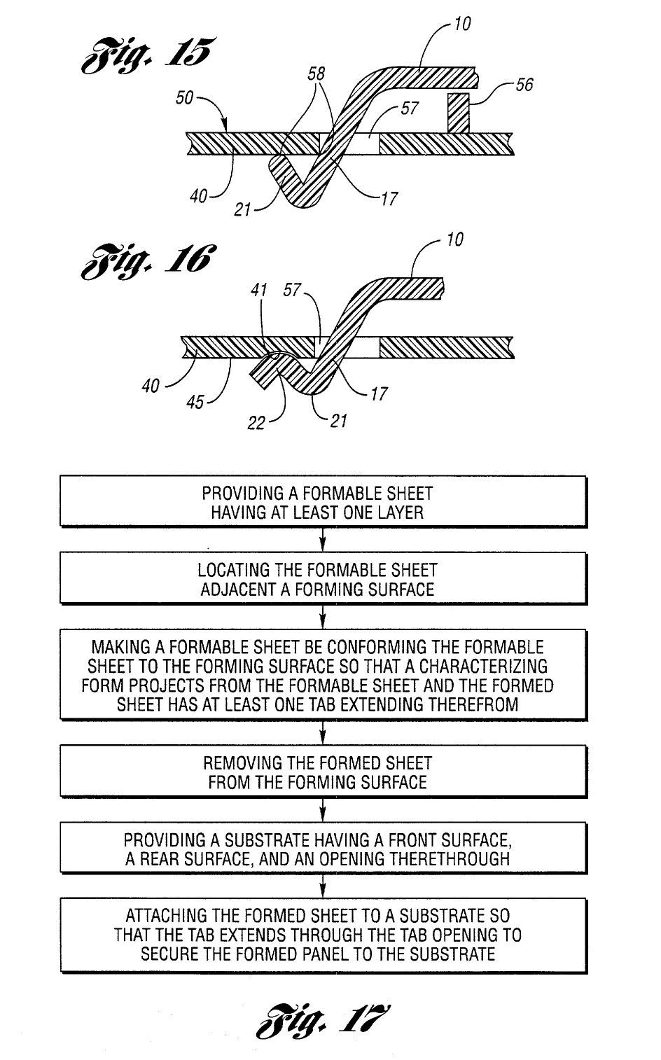

The insert panel 10 is pushed down onto the substrate 40 so that the tabs 17 are forced through the tab openings 57. Alternatively, the insert panel 10 may be squeezed so that the tabs 17 are closer together to allow the tabs to more easily fit through the tab openings 57. Once the tabs 17 are through the tab openings 57, the tabs snap back so that a portion 21 of the tab is under the substrate 40 to prevent the insert panel 10 from coming out. Further, spring tension from the tab 17 exerted at the contact points 58 between the tab and the substrate, as shown in FIG. 15, helps maintain the insert panel 10 in its proper location. Additionally, the front surface 50 of the substrate 40 or a projection 56 extending outwards from the front surface of the substrate can limit downward movement of the insert panel 10. Substrate 40 may have contour formed in the area behind insert panel 10 to limit downward movement.

The tabs 17 can be manufactured having various designs. For example, the tabs 17 may have a flat portion 21 under the substrate (as shown in FIG. 14), an angled portion 21 pointing towards the substrate (as shown in FIG. 15), or an S-shaped portion under the substrate (as shown in FIG. 16). Further, an indent 41 in rear surface 45 of substrate 40 can be used to receive a portion of the tab as shown is FIG. 16 to help maintain the portion in place. It should be appreciated that the snap designs include various configurations of openings, snap shapes, insert panel forms, and standoffs. Only three conformations are shown. “Hook and snap” designs such as in U.S. Pat. No. 4,974,698 may be incorporated. Undercuts may be incorporated to hide openings from view.

FIG. 17 illustrates a method of making the composite panel 1 and using the snap-fit attachment illustrated and described in relation to FIGS. 6-8 and 14-16, respectively. The method described in FIG. 17 requires providing a substrate having a front surface, a rear surface, and a tab opening therethrough instead of a larger opening through which the characterizing topography extends. The method described in FIG. 17 attaches the formed sheet to the substrate by extending the tab through the tab opening to secure the formed panel to the substrate.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a composite panel comprising:
providing a formable sheet having at least one layer;
locating the formable sheet adjacent to a forming surface;
making a formed sheet by conforming the formable sheet to the forming surface so that a characterizing topography projects from the formable sheet;
removing the formed sheet from the forming surface;
providing a substrate having a front surface, a rear surface, and an opening therethrough; and
attaching the formed sheet to the rear surface of the substrate so that the characterizing topography appears through the opening.

2. The method of claim 1 wherein the substrate further comprises a plurality of bosses extending from the rear surface.

3. The method of claim 2 further comprising the step of:
forming a plurality of openings through the formed sheet before the formed sheet is attached to the substrate.

4. The method of claim 3 wherein the step of attaching the formed sheet to the substrate comprises placing the formed sheet on the substrate so that at least one of the plurality of bosses extends through one of the plurality of openings.

5. The method of claim 4 wherein the step of attaching the formed sheet to the substrate further comprises the step of:
heat staking the bosses extending through the holes in the formed sheet.

6. The method of claim 4 wherein the step of attaching the formed sheet to the substrate further comprises the step of:
upsetting the bosses extending through the openings in the formed sheet.

7. The method of claim 1 wherein the step of attaching the formed sheet to the substrate further comprises applying adhesive to a portion of at least one of the formed sheet and substrate.

8. The method of claim 1 wherein the step of providing a formable sheet comprises the step of providing a sheet with at least one simulated wood grain layer.

9. The method of claim 1 wherein the step of providing a formable sheet comprises the step of providing a sheet with at least one decorative layer.

10. The method of claim 1 further comprising the step of:
trimming the formed sheet before attaching the formed sheet to the substrate.

11. A composite panel comprising:
a substrate having a front and a rear surface, an opening therethrough;
an insert panel having a characterizing topography extending therefrom;
wherein the insert panel is located on the rear surface of the substrate so that the characterizing topography appears through the opening; and
means to secure the insert panel to the substrate.

12. The composite panel of claim 11 wherein the substrate further comprises a plurality of bosses extending from the back surface, the insert panel further comprises a plurality of openings on the flat plane corresponding to the bosses, and wherein the insert panel is placed on the substrate so that at least one of the plurality of bosses extends through at least one of the plurality of openings.

13. The composite panel of claim 12 wherein the means for securing the insert panel to the substrate comprises a mechanical lock formed in the bosses extending through the openings.

14. The composite panel of claim 13 wherein the mechanical lock is formed by means for heat staking the bosses that extend through the openings.

15. The composite panel of claim 13 wherein the mechanical lock is formed by means for upsetting the bosses that extend through the openings.

16. The composite panel of claim 11 wherein means for securing the insert panel to the substrate comprise adhesive applied to a portion of at least one of the insert panel or substrate.

17. The composite panel of claim 11 wherein the insert panel comprises a plurality of layers.

18. The composite panel of claim 17 wherein one or more of the layers has a wood grain finish.

19. A method of making a composite panel comprising:
providing a formable sheet having at least one layer;
locating the formable sheet adjacent a forming surface;
making a formed sheet by conforming the formable sheet to the forming surface so that a characterizing form projects from the formable sheet and by forming a tab extending from the formed sheet;
removing the formed sheet from the forming surfaces;
providing a substrate having a front surface, a rear surface, and a tab opening therethrough; and
attaching the formed sheet to the substrate so that at least one tab extends through the tab opening to secure the formed panel to the substrate.

20. A composite panel comprising:
a substrate having a front and a rear surface;
at least one tab opening extending therethrough;
an insert panel having a characterizing topography and at least one tab extending therefrom;
wherein the insert panel is placed on the front surface of the substrate and the tab extends through the tab opening to secure the insert panel to the substrate.
